(19) United States
(12) Patent Application Publication
(10) Pub. No.: US 2016/0147739 A1
(43) Pub. Date: May 26, 2016

(54) APPARATUS AND METHOD FOR UPDATING LANGUAGE ANALYSIS RESULT

(71) Applicant: Electronics and Telecommunications Research Institute, Daejeon (KR)

(72) Inventors: Joon Ho LIM, Daejeon (KR); Hyun Ki KIM, Daejeon (KR); Pum Mo RYU, Daejeon (KR); Yong Jin BAE, Daejeon (KR); Hyo Jung OH, Daejeon (KR); Chung Hee LEE, Daejeon (KR); Soo Jong LIM, Daejeon (KR); Myung Gil JANG, Daejeon (KR); Mi Ran CHOI, Daejeon (KR); Jeong HEO, Daejeon (KR)

(21) Appl. No.: 14/932,425

(22) Filed: Nov. 4, 2015

(30) Foreign Application Priority Data
Nov. 20, 2014 (KR) 10-2014-0162397

(51) Int. Cl. G06F 17/28

(52) U.S. Cl. CPC G06F 17/28

(57) ABSTRACT

An apparatus and method for updating a language analysis result are provided. The apparatus includes a storage unit configured to store language analysis result and language analysis metadata to be used for update of the language analysis result, and an update unit configured to reanalyze the language analysis metadata based on language knowledge which is added to language knowledge resources, and update the language analysis result based on the reanalyzed result.

### CROSS-REFERENCE TO RELATED APPLICATION

This application claims priority to and the benefit of Korean Patent Application No. 10-2014-0162397, filed on Nov. 20, 2014, the disclosure of which is incorporated herein by reference in its entirety.

### BACKGROUND

1. Field of the Invention

The present invention relates to an apparatus and method for updating a language analysis result, and more particularly, to an apparatus and method for updating a language analysis result by automatically detecting incorrect analytical language among a large amount of language analysis results.

2. Discussion of Related Art

Generally, knowledge base technology, language analysis technology, language analysis application technology, etc. are used to analyze language. Knowledge base technology is technology in which text is analyzed on-line and a knowledge base is continuously expanded and accumulated, such as never ending language learner (NELL), Freebase, yet another great ontology (YAGO), etc.

For example, NELL is knowledge base technology of searching for information on the Internet for twenty four hours and expanding language knowledge, and continuously expanding language knowledge for itself while understanding meanings of words and sentences by constantly searching for, comparing, and analyzing the words and the sentences.

The language analysis technology is natural language processing technology such as sentence separation, morpheme analysis, word sense analysis, named entity analysis, syntactic structure analysis, semantic analysis, coreference analysis, omission and restoration.

The language analysis technology for each step is technology of performing a language analysis by referencing language knowledge resources internally including a knowledge base.

The language analysis application technology includes word pair extraction technology for information retrieval based on a result analyzed by the language analysis technology, and relation extraction technology for extracting relation information expressed in a sentence, etc.

Meanwhile, since conventional technology (language analysis technology) used for analyzing language has high computational complexity and requires a great deal of processing time, an operation of analyzing language in a massive document once and then analyzing the language in the massive document again has a problem in that effectiveness deteriorates in terms of effective and time.

That is, the conventional language analysis technology has a problem in that performance of an improved language analyzer (language analysis capability of a more precise language analyzer) before analyzing the massive document again using the improved language analyzer even when performance of a language analyzer is improved cannot be reflected in a language analysis result which is previously analyzed.

Accordingly, an operation of performing the language analysis on the massive document again for reflecting the performance of the language analyzer improved due to the problem described above in the language analysis result which is previously analyzed has a problem in that the effectiveness deteriorates since the computational complexity is high and a great deal of processing time is required even when it is for the purpose of improving the preciseness of the language analysis result.

### SUMMARY OF THE INVENTION

The present invention is directed to an apparatus and method for updating a language analysis result updating the language analysis result analyzed by performing a more exact analysis based on a portion which is incorrectly analyzed in the language analysis result which is previously analyzed with respect to a massive document and language knowledge which is newly added (according to knowledge base expansion).

According to one aspect of the present invention, there is provided an apparatus for updating a language analysis result, including: a storage unit configured to store the language analysis result and language analysis metadata to be used for update of the language analysis result; and an update unit configured to reanalyze the language analysis metadata based on language knowledge which is added to language knowledge resources, and update the language analysis result based on the reanalyzed result.

The language analysis metadata may include at least one among time stamp information, language analysis version information, document ID information, domain information, sentence ID information, original document information, tag information, processing module information, unit input information, unit result information, reliability information, and reserve information.

The update unit may include a detection unit configured to detect resource increase statistical information and added word information based on added language knowledge when it is confirmed that the language knowledge is added to the language knowledge resources; a determination unit configured to select the language analysis metadata to be reanalyzed among the stored language analysis metadata based on the resource increase statistical information and the added word information detected by the detection unit; and an analysis unit configured to perform a subdivided analysis on the unit input information of the selected language analysis metadata using the processing module information of the language analysis metadata selected by the determination unit.

The update unit may select the language analysis metadata in which an increase value of the domain information or the tag information is equal to or more than a predetermined reference increase value among the stored language analysis metadata based on the detected resource increase statistical information and the added word information.

The update unit may perform the subdivided analysis on the unit input information of the selected language analysis metadata using the processing module information of the selected language analysis metadata, and output subdivided analysis result information and reliability information according to the subdivided analysis.

The update unit may compare the subdivided analysis result information output by the analysis unit and the unit result information of the selected language analysis metadata, and when it is determined that the subdivided analysis result information and the unit result information are not identical based on the comparison result, determine whether the reliability information output by the analysis unit and the reliability information of the selected language analysis metadata are within a predetermined range.

The update unit may perform the subdivided analysis on the selected language analysis metadata again using the language knowledge added from a processing module included in the processing module information of the selected language analysis metadata when the reliability information output based on the determination result and the reliability information of the selected language analysis metadata are not within the predetermined range.

The update unit may update the language analysis result corresponding to the selected language analysis metadata among the stored language analysis result based on a reanalyzed result obtained by performing the subdivided analysis again on the selected language analysis metadata.

The update unit may store the language analysis metadata to be used for update of the language analysis result in which the reliability value is equal to or less than a predetermined reliability value in the storage unit when the reliability value corresponding to the language analysis result among the language analysis results obtained by performing the language analysis is equal to or less than the predetermined reliability value.

The storage unit may include a language analysis result storage region configured to store the language analysis result; and a language analysis metadata storage region configured to store the language analysis metadata.

According to another aspect of the present invention, there is provided a method of updating a language analysis result, including: storing the language analysis result and language analysis metadata to be used for update of the language analysis result; and reanalyzing the language analysis metadata based on language knowledge which is added to language knowledge resources, and updating the language analysis result based on the reanalyzed result.

The language analysis metadata may include at least one among time stamp information, language analysis version information, document ID information, domain information, sentence ID information, original document information, tag information, processing module information, unit input information, unit result information, reliability information, and reserve information.

The updating of the language analysis result may include: detecting resource increase statistical information and added word information based on added language knowledge when it is confirmed that the language knowledge is added to the language knowledge resources; selecting the language analysis metadata to be reanalyzed among the stored language analysis metadata based on the detected resource increase statistical information and the added word information; and performing a subdivided analysis with respect to the unit input information of the language analysis metadata selected using the processing module information of the selected language analysis metadata.

The selecting of the language analysis metadata may select the language analysis metadata in which an increase value of the domain information or the tag information is equal to or more than a predetermined increase value based on the detected resource increase statistical information and the added word information among the stored language analysis metadata.

The performing of the subdivided analysis may include: performing the subdivided analysis on the unit input information of the language analysis metadata selected using the processing module information of the selected language analysis metadata; and outputting subdivided analysis result information and reliability information according to the subdivided analysis.

The performing of the subdivided analysis may further include: comparing the output subdivided analysis result information and the unit result information of the selected language analysis metadata; and when it is determined that the subdivided analysis result information and the unit result information are not identical based on the comparison result, determining whether the reliability information output by an analysis unit and the reliability information of the selected language analysis metadata are within a predetermined range.

The performing of the subdivided analysis may further include: performing the subdivided analysis on the selected language analysis metadata using the language knowledge added from a processing module included in the processing module information of the selected language analysis metadata when the reliability information output based on the determination result and the reliability information of the selected language analysis metadata are not within the predetermined range.

The updating of the language analysis result may update the language analysis result corresponding to the selected language analysis metadata among the stored language analysis results based on the reanalyzed result obtained by performing the subdivided analysis again with respect to the selected language analysis metadata.

The storing of the language analysis metadata may include: determining whether the reliability value corresponding to the language analysis result is equal to or less than a predetermined reliability value among the language analysis results obtained by performing the language analysis; and storing the language analysis metadata to be used for update of the language analysis result in which the reliability value is equal to or less than the predetermined reliability value when the reliability value corresponding to the language analysis result is equal to or less than the predetermined reliability value based on the determination result.

The storing of the language analysis metadata may include: storing the language analysis result in a language analysis storage region; and storing the language analysis metadata in a language analysis metadata storage region.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a configuration of an apparatus for updating a language analysis result according to an embodiment of the present invention;

FIG. 2 is a block diagram illustrating a detailed configuration of an analysis unit of FIG. 1; and

FIG. 3 is an operational flowchart for describing a method of updating a language analysis result according to an embodiment of the present invention.

### DETAILED DESCRIPTION OF EXEMPLARY EMBODIMENTS

The above and other objects, features and advantages of the present invention will become more apparent to those of ordinary skill in the art by describing in detail exemplary embodiments thereof with reference to the accompanying drawings.

Hereinafter, exemplary embodiments of the present invention will be described in detail below with reference to the accompanying drawings. However, the present invention is not limited to exemplary embodiments which will be described hereinafter, and can be implemented by various different types. Exemplary embodiments of the present invention are described below in sufficient detail to enable those of ordinary skill in the art to embody and practice the present invention. The present invention is defined by claims.

Meanwhile, the terminology used herein to describe exemplary embodiments of the invention is not intended to limit the scope of the invention. In this specification, the articles “a,” “an,” and “the” are singular in that they have a single referent, but the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Hereinafter, an apparatus and method for updating a language analysis result according to an embodiment of the present invention will be described in detail with reference to the accompanying drawings.

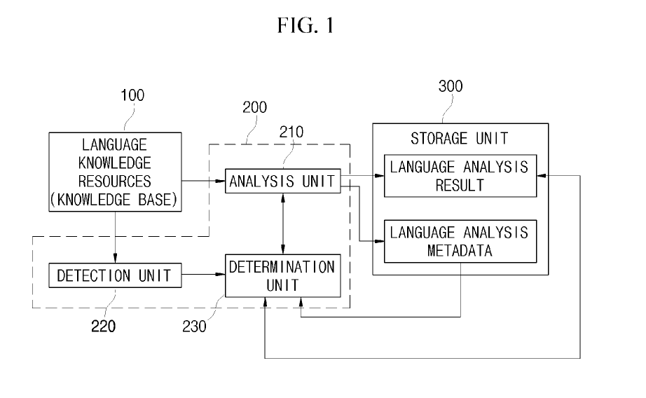

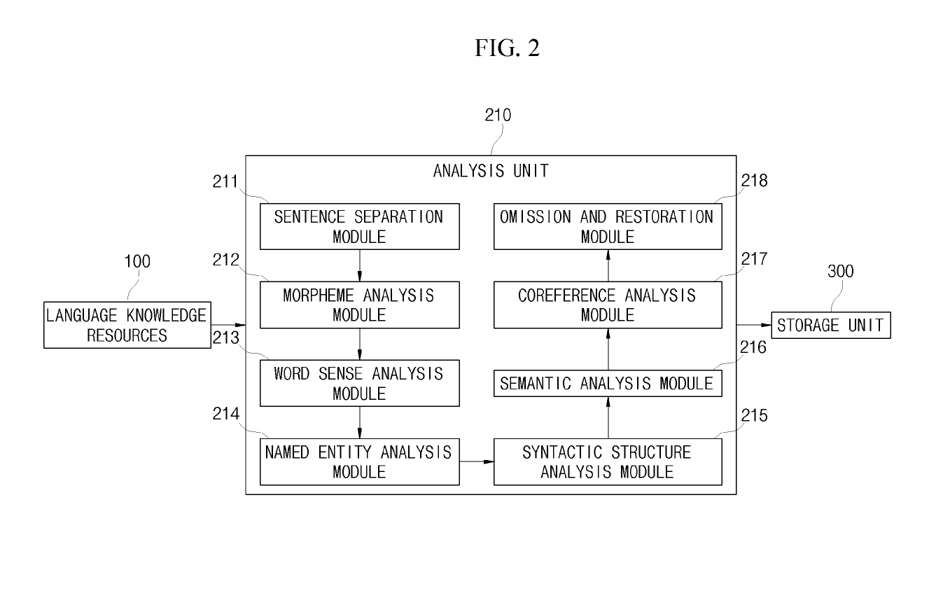

First, the apparatus for updating the language analysis result according to an embodiment of the present invention will be described with reference to FIGS. 1 and 2. Here, FIG. 1 is a block diagram illustrating a configuration of an apparatus for updating a language analysis result according to an embodiment of the present invention, and FIG. 2 is a block diagram illustrating a detailed configuration of an analysis unit of FIG. 1.

As shown in FIG. 1, the apparatus for updating the language analysis result according to an embodiment of the present invention may include language knowledge resources 100, an update unit 200, and a storage unit 300.

The language knowledge resources 100 may be a knowledge base, and analyze text big data of continuously increasing like Wikipedia, news, blogs, and continuously expand language knowledge such as an object name list (a movie title, a drama title, a book title, a character name, etc.), its classification, a word network (a wordnet, etc.), a relation base (person-CEO-company, person-production-movie, person-appearance-movie, etc.).

For example, the language knowledge resources 100 may extract a new object name and its classification information from the text big data, and continuously expand the object name list by verifying the extracted new object name and its classification information.

Further, the language knowledge resources 100 may recognize a relation between words from the text big data, and continuously expand the word network by verifying the relation between the recognized words.

Moreover, the language knowledge resources 100 may extract a new relation from the text big data, and continuously expand the relation base by verifying the extracted new relation.

The update unit 200 may reanalyze language analysis metadata based on language knowledge added to the language knowledge resources 100, and update a language analysis result in the storage unit 300 based on the reanalyzed result.

The update unit 200 may include an analysis unit 210, a detection unit 220, and a determination unit 230 as shown in FIG. 2.

The analysis unit 210 may include a sentence separation module 211, a morpheme analysis module 212, a word sense analysis module 213, a named entity analysis module 214, a syntactic structure analysis module 215, a semantic analysis module 216, a coreference analysis module 217, and an omission and restoration module 218.

The analysis unit 210 may perform a language analysis on a document in which general text such as a Web, a book, etc. is included using the language knowledge resources 100.

The analysis unit 210 may perform the language analysis by subdividing the language analysis on the document using each of the modules 211 to 218.

Each of the modules 211 to 218 may perform the subdivided language analysis on the document in which the general text such as the Web, the book, etc. is included, and output the subdivided analysis result and a reliability value corresponding to the subdivided analysis result.

First, the sentence separation module 211 may separate the general text such as the Web, the book, etc. as a sentence.

The morpheme analysis module 212 may analyze a morpheme such as a noun, a verb, a suffix, etc. in the sentence in which the general text is separated by the sentence separation module 211.

The word sense analysis module 213 may analyze a word meaning in order to solve ambiguity of homonyms and polysemic words in the sentence in which the morpheme is analyzed by the morpheme analysis module 212.

The named entity analysis module 214 may analyze a noun phrase (an object name) indicating a unique object such as a movie title, a place name, etc. using the language knowledge resources 100 in the sentence in which the word meaning is analyzed by the word sense analysis module 213.

The syntactic structure analysis module 215 may analyze a structural (connection) relation between words in the sentence in which the object name is analyzed by the named entity analysis module 214.

The semantic analysis module 216 may analyze expression semantic information in the sentence in which the connection relation between words is analyzed by the syntactic structure analysis module 215 (SRL: Semantic Role Labeling).

The coreference analysis module 217 may analyze expressions indicating the same object in a sentence in which the expression semantic information is analyzed by the semantic analysis module 216 and between the sentences.

The omission and restoration module 218 may recognize and restore an omitted component in the sentence or sentences in which the expression indicating the same object in the sentence and between the sentences is analyzed.

As described above, the analysis unit 210 may perform the language analysis by subdividing a language analysis using each of the modules 211 to 218 with respect to a document in which the general text (sentence) such as the Web, the book, etc. is included, and store a language analysis result in the storage unit 300.

Further, the analysis unit 210 may store language analysis metadata to be used when determining whether to update the stored language analysis result in the storage unit 30.

For example, as shown in the following Table 1, the analysis unit 210 may generate a look-up table having identification items such as a time stamp, a language analysis version, a document ID, a domain, a sentence ID, an original document, a tag, a processing module, a unit input, a unit result, reliability, and reserve. The analysis unit 210 may store the language analysis metadata in the storage unit 300 using the generated look-up table.

TABLE 11

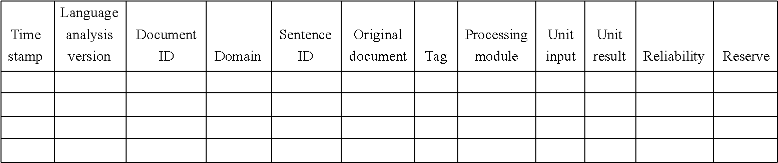

Hereinafter, an operation of storing the language analysis metadata according to the language analysis operation of the analysis unit 210 will be described.

The analysis unit 210 may store language analysis operation time information about the document in which the general text (document) such as the Web, the book, etc. is included by corresponding to the time stamp of the ID items.

The analysis unit 210 may store its own version information by corresponding to the language analysis version of the ID items.

The analysis unit 210 may store the unique ID of a document in which the language analysis operation is performed by corresponding to the document ID of the ID items.

The analysis unit 210 may use conventional automatic document classification technology and classify a topic (movies, music, sports, cars, etc.) of the document using domain classification which is compatible with a hierarchy of the language knowledge resources 100. The analysis unit 210 may store the classified document field information by corresponding to the domain of the ID items.

The analysis unit 210 may store the unique ID of the sentence by corresponding to the document ID of the ID items.

The analysis unit 210 may store the sentence original document information by corresponding to the original document of the ID items.

The analysis unit 210 may store the object name included in the sentence and a word in which the frequency number in the document is smaller than a predetermined frequency number by corresponding to the tag of the ID items.

For example, the analysis unit 210 may store “Kiera Nightley (object name)”, “begin”, and “again (a word in which the frequency number is smaller than the predetermined frequency number)” by corresponding to the tag of the ID items in a sentence “I really like a song of Kiera Nightley played in the movie “begin again””.

The analysis unit 210 may store information of the module outputting the subdivided analysis result corresponding to a reliability value which is smaller than a predetermined reference reliability value by corresponding to the processing module of the ID items.

For example, the analysis unit 210 may store the syntactic structure analysis module information by corresponding to the processing module of the ID items when the reliability value corresponding to the subdivided analysis result output by the syntactic structure analysis module 215 is smaller than the predetermined reference reliability value.

The analysis unit 210 may process (classify) the sentence as input data according to each of the modules 211 to 218 using a probabilistic model, a discriminative model, etc. before analyzing by subdividing the sentence using each of the modules 211 to 218.

Each of the modules 211 to 218 may analyze by subdividing the input data, and output a subdivided analysis result or a reliability value corresponding to the subdivided analysis result.

The analysis unit 210 may store the input data input to the module outputting the subdivided analysis result corresponding to the reliability value which is smaller than the predetermined reference reliability value among the subdivided analysis results output by each of the modules 211 to 218 by corresponding to the unit input of the ID items.

For example, suppose that the syntactic structure analysis module 215 performs a syntactic structure analysis operation on the input data “I really like a song of Kiera Nightley played in the movie “begin again””, and outputs the syntactic structure analysis result indicating that a word phrase “played” and a word phrase “song” are connected (“played-song”).

Here, since the word phrase “played” may modify the word phrase “of Kiera Nightley” and the word phrase “song”, the syntactic structure analysis module 215 may output the syntactic structure analysis result indicating that the word phrase “played” and the word phrase “song” are connected. Further, when the reliability value of the output syntactic structure analysis result is smaller than the predetermined reference reliability value, the analysis unit 210 may store the input data “I really like a song of Kiera Nightley played in the movie “begin again”” by corresponding to the unit input of the ID items.

The analysis unit 210 may store the subdivided analysis result corresponding to the reliability value which is smaller than the predetermined reference reliability value among the subdivided analysis results output by each of the modules 211 to 218 by corresponding to the unit result of the ID items.

For example, suppose that the syntactic structure analysis module 215 may perform the syntactic structure analysis operation on the input data “I really like a song of Kiera Nightley played in the movie “begin again””, and output the syntactic structure analysis result indicating that the word “played” and the word “song” are connected.

Here, since the word phrase “played” may modify the word phrase “of Kiera Nightley” and the word phrase “song”, the syntactic structure analysis module 215 may output the syntactic structure analysis result indicating that the word phrase “played” and the word phrase “song” are connected (“played-song”). Further, when the reliability value of the output syntactic structure analysis result is smaller than the predetermined reference reliability value, the analysis unit 210 may store the syntactic structure analysis result indicating that the word phrase “played” and the word phrase “song” are connected (“played-song”) by corresponding to the unit result of the ID items.

The analysis unit 210 may store the reliability value which is smaller than the predetermined reference reliability value among the reliability values corresponding to the subdivided analysis results output by each of the modules 211 to 218 by corresponding to the reliability of the ID items.

The analysis unit 210 may store information needed for an automatic update operation among the subdivided analysis results corresponding to the reliability values which are smaller than the predetermined reference reliability value among the subdivided analysis results analyzed by subdividing the sentence using each of the modules 211 to 218 by corresponding to the reserve of the ID items.

As described above, the analysis unit 210 may store information related to the subdivided analysis result corresponding to the reliability value which is smaller than the predetermined reference reliability value among the subdivided analysis results output by each of the modules 211 to 218 as language analysis metadata using the look-up table.

The determination unit 230 shown in FIG. 2 may select the language analysis metadata which should be reanalyzed among the language analysis metadata stored by the analysis unit 210, and request the reanalysis of the selected language analysis metadata from the analysis unit 210.

Hereinafter, an operation in which the determination unit 230 selects the language analysis metadata which has to be reanalyzed using the language analysis metadata stored in the language knowledge resources 100 and the storage unit 300 which are continuously increasing, and requests the reanalysis, and updates the language analysis result according to the reanalyzed result will be described.

The detection unit 220 may detect language knowledge accumulation of the language knowledge resources 100 according to the continuous increase, and transmit the detected result information to the determination unit 230.

For example, the detection unit 220 may detect the increment of entry for each day and each field of the language knowledge resources 100, detect a word (an object name, a wordnet, a relation word, etc.), etc. which is newly added to the language knowledge resources 100, and transmit the detected information to the determination unit 230.

The determination unit 230 may select the language analysis metadata which has to be reanalyzed based on the detection information transmitted from the detection unit 220. That is, the determination unit 230 may select the language analysis metadata which is more exactly analyzable (which is needed to be updated) at a present time among the language analysis metadata stored in the storage unit 300 using the language knowledge added to the language knowledge resources 100.

The determination unit 230 may test the language analysis metadata selected as that needing to be updated using the language knowledge which is newly added to the language knowledge resources 100. The determination unit 230 may determine whether to reanalyze the language analysis metadata selected as being needed to be updated according to the tested result. The determination unit 230 may request the reanalysis with respect to the language analysis metadata in which it is determined that the reanalysis is required from the analysis unit 210.

The analysis unit 210 may perform the reanalysis on the language analysis metadata in which the reanalysis is requested by the determination unit 230 using the language knowledge added to the language knowledge resources 100, and transmit the reanalysis result to the determination unit 230.

The determination unit 230 may update the language analysis result corresponding to the reanalyzed language analysis metadata among the stored language analysis results based on the reanalyzed result transmitted from the analysis unit 210.

Hereinafter, an operation of selecting the language analysis metadata to be reanalyed is required and reanalyzing the selected language analysis metadata will be described in more detail.

The detection unit 220 may detect resource increase statistical information for each day and each field and the newly added word information from the language knowledge resources 100 in which the knowledge is continuously accumulated. The detection unit 220 may transmit the detected resource increase statistical information for each day and each field and the newly added word information to the determination unit 230.

The determination unit 230 may select the language analysis metadata which is a test target for determining whether the reanalysis is required among the stored language analysis metadata based on the resource increase statistical information for each day and each field of the language knowledge resources 100 transmitted from the detection unit 220 and the word information which is newly added to the language knowledge resources 100.

For example, the determination unit 230 may perform a statistical analysis on each data and each field with respect to time stamp information and domain information of the stored language analysis metadata based on the resource increase statistical information for each day and each field transmitted from the detection unit 220.

That is, the determination unit 230 may select the language analysis metadata in which time stamp information (the language analysis operation time information) is a time before the present time among the stored language analysis metadata. The determination unit 230 may select again the language analysis metadata in which the language knowledge increase value [the resource increase for each day and each field of the language knowledge resources 100 of domain information (document field information) is equal to or more than a predetermined threshold value among the selected language analysis metadata. The determination unit 230 may specify the language analysis metadata which is selected again as a test target for determining whether to reanalyze.

Further, the determination unit 230 may analyze tag information (word information) of the language analysis metadata based on the word information which is newly added to the language knowledge resources 100 transmitted from the detection unit 220.

That is, the determination unit 230 may select the language analysis metadata in which the time stamp information (the language analysis operation time information) is a time before a present time among the stored language analysis metadata. The determination unit 230 may select again the language analysis metadata in which the language knowledge increase value [the increase value of the word information added to the language knowledge resources 100] of tag information is equal to or more than a predetermined threshold value among the selected language analysis metadata. The determination unit 230 may specify the language analysis metadata which is selected again as a test target for determining whether to reanalyze.

The determination unit 230 may perform the test for determining whether to reanalyze based on processing module information, unit input information, unit result information, and reliability information of the language analysis metadata which is specified as the test target.

For this, the determination unit 230 may request the test with respect to the unit input information (the input data) using the processing module information of the language analysis metadata which is specified as the test target from the analysis unit 210.

For example, the determination unit 230 may request the test with respect to the input data “I really like a song of Kiera Nightley played in the movie “begin again”” using the syntactic structure analysis module 215 of the language analysis metadata which is specified as the test target from the analysis unit 210.

The analysis unit 210 may perform the test through the processing module on the input data of the language analysis metadata which is specified as the test target in response to a request of the determination unit 230 using the language knowledge resources 100 in which the language knowledge is accumulated according to the continuous increase.

For example, the analysis unit 210 may allow the syntactic structure analysis module 215 to perform the test (the syntactic structure analysis operation) on the input data “I really like a song of Kiera Nightley played in the movie “begin again”” using the language knowledge resources 100 in which the language knowledge is accumulated according to the continuous increase in response to the request of the determination unit 230.

The analysis unit 210 may test the unit input information of the language analysis metadata which is specified as the test target using the processing module information, and transmit the test result and the reliability value corresponding to the test result to the determination unit 230.

The determination unit 230 may compare the test result information transmitted from the analysis unit 210 and the unit result information of the language analysis metadata which is specified as the test target.

Based on the comparison result, when the test result information transmitted from the analysis unit 210 and the unit result information of the language analysis metadata which is specified as the test target are not identical, the determination unit 230 may test whether the reliability value corresponding to the test result information and the reliability information (reliability value) of the language analysis metadata which is specified as the test target are within a statistically predetermined significant range using a statistical test method such as a t-test, etc.

Based on the test result, when the reliability value corresponding to the test result information and the reliability information (reliability value) of the language analysis metadata which is specified as the test target are not within the statistically predetermined significant range, the determination unit 230 may determine that the language analysis metadata which is specified as the test target is reanalyzed. The determination unit 230 may request the analysis unit 210 to perform the language analysis operation again on the language analysis metadata for which it is determined that the reanalysis is required after the processing module.

For example, the determination unit 230 may request the analysis unit 210 to perform the language analysis operation again on the language analysis metadata which is specified as the test target using the syntactic structure analysis module 215, the semantic analysis module 216, the coreference analysis module 217, and the omission and restoration module 218.

The analysis unit 210 may perform the language analysis operation on the language analysis metadata on which the determination unit 230 has requested that the language analysis operation be performed again after the processing module.

For example, the analysis unit 210 may perform the language analysis operation again on the language analysis metadata on which it has been requested that the language analysis operation be performed again through the syntactic structure analysis module 215, the semantic analysis module 216, the coreference analysis module 217, and the omission and restoration module 218, and transmit the result of performing the language analysis again to the determination unit 230.

The determination unit 230 may update the language analysis result corresponding to the language analysis metadata in which the language analysis operation is performed again among the language analysis results stored in the storage unit 300 based on the language analysis result which is performed again transmitted from the analysis unit 210.

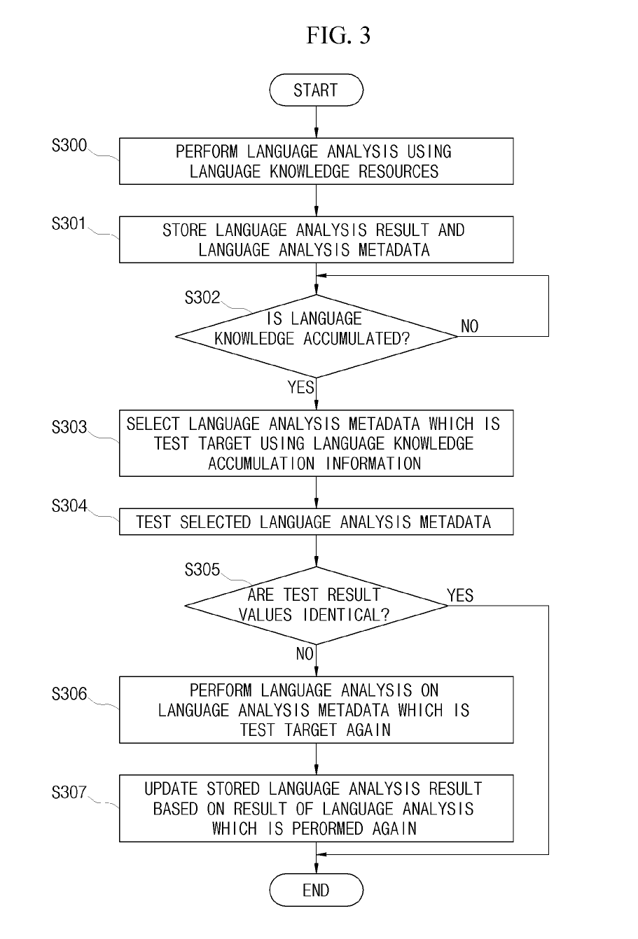

Hereinafter, a method of updating a language analysis result according to an embodiment of the present invention will be described with reference to FIG. 3. FIG. 3 is an operational flowchart for describing a method of updating a language analysis result according to an embodiment of the present invention.

As shown in FIG. 3, first, a language analysis operation may be performed on a document in which general text such as the Web, the book, etc. is included using the language knowledge resources (S300).

For example, the general text such as the Web, the book, etc. may be separated as the sentence. The morpheme such as a noun, a verb, a suffix, etc. may be analyzed in the sentence in which the general text is separated. The word meaning may be analyzed in order to solve ambiguity of homonyms and polysemic words in the sentence in which the morpheme is analyzed. The noun phrase (the object name) indicating the unique object such as the movie title, the place name, etc. may be analyzed using the language knowledge resources in the sentence in which the word meaning is analyzed. A structural (connection) relation between the words may be analyzed in the sentence in which the object name is analyzed. The expression semantic information may be analyzed in the sentence in which the connection relation between the words is analyzed (SRL). The expression indicating the same target may be analyzed in the sentence in which the expression semantic information is analyzed and between the sentences. The omitted component may be recognized in the sentence in which the expression indicating the same target in the sentence and between sentences is analyzed, and the omission component may be restored.

As described above, the language analysis operation may be performed by subdividing the language analysis with respect to the document including the general text (sentence) such as the Web, the book, etc., be performed for each processing step, and store the language analysis result. Further, the language analysis metadata to be used when determining whether to update the stored language analysis result may be stored (S301).

For example, the look-up table having the ID items such as the time stamp, the language analysis version, the document ID, the domain, the sentence ID, the original document, the tag, the processing module, the unit input, the unit result, the reliability, and the reserve may be generated. The language analysis metadata may be stored using the generated look-up table.

That is, the language analysis operation time information with respect to the document in which the general text such as the Web, the book, etc. is included may be stored by corresponding to the time stamp of the ID items, and the analysis version information may be stored by corresponding to the language analysis version of the ID items.

Further, the unique ID of the document which the analysis is performed may be stored by corresponding to the document ID of the ID items, and classify the field (a movie, a music, a sport, a car, etc.) of the document using conventional automatic document classification technology and domain classification which is compatible with a hierarchy of the language knowledge resources.

The classified document field information may be stored by corresponding to the domain of the ID items, and the unique ID of the document may be stored by corresponding to the document ID of the ID items.

Further, the sentence original document information may be stored by corresponding to the original document of the ID items, and the object name included in the sentence and the word in which the frequency number in the document is smaller than the predetermined reference frequency number may be stored by corresponding to the tag of the ID items.

Meanwhile, the processing step information outputting the subdivided analysis result corresponding to the reliability value which is smaller than the predetermined reference frequency number may be stored by corresponding to the processing step of the ID items. The sentence may be processed as the input data according to each processing step, and the processed input data may be input to each processing step. Each processing step may analyze by subdividing the input data, and output the subdivided analysis result and the reliability value corresponding to the subdivided analysis result.

The input data input to the processing step outputting the subdivided analysis result corresponding to the reliability value which is smaller than the predetermined reference reliability value among the subdivided analysis results output by each processing step may be stored by corresponding to the unit input of the ID items.

Further, the subdivided analysis result corresponding to the reliability value which is smaller than the predetermined reference reliability value among the subdivided analysis results output by each processing step may be stored by corresponding to the unit result of the ID items.

Meanwhile, the reliability value which is smaller than the predetermined reference reliability value among the reliability values corresponding to the subdivided analysis result output by each processing step may be stored by corresponding to the reliability of the ID items, and the information needed for the automatic update among the subdivided analysis results analyzed by subdividing the sentence using each processing step may be stored by corresponding to the reserve of the ID items.

As described above, the information according to the subdivided analysis result in which the reliability value among the subdivided analysis result output by each processing step is smaller than the predetermined reference reliability value may be stored as the language analysis metadata using the look-up table.

Continuously, as shown in FIG. 3, whether the language knowledge of the language knowledge resources is accumulated according to the continuous increase may be determined (S302).

Based on the determination result, when it is determined that the language knowledge of the language knowledge resources is accumulated, the resource increase statistical information for each day and each field from the language knowledge resources in which the language knowledge is accumulated and the newly added word information may be detected.

The language analysis metadata which is the test target for determining whether to reanalyze may be selected among the stored language analysis metadata based on the detected resource increase statistical information for each day and each field and the newly added word information (S303).

For example, the statistical analysis for each day and each field may be performed based on the detected resource increase statistical information for each day and each field with respect to the time stamp information and the domain information of the stored language analysis metadata.

That is, the language analysis metadata in which the time stamp information (the language analysis operation time information) is a time before the present time may be selected among the stored language analysis metadata. The language analysis metadata in which the language knowledge increase value [the resource increase value for each day and each field of the language knowledge resources] of the domain information (the document field information) is equal to or more than the predetermined threshold value may be selected again among the selected language analysis metadata.

The language analysis metadata which is selected again may be specified as the test target for determining whether to reanalyze.

Further, the tag information (the word information) of the language analysis metadata may be analyzed based on the word information which is newly added to the detected language resources.

That is, the language analysis metadata in which the time stamp information (the language analysis operation time information) is a time before the preset time may be selected among the stored language analysis metadata.

The language analysis metadata in which the language knowledge increase value [the increase value of the language information which is newly added to the language knowledge resources] of the tag information among the selected language analysis metadata is equal to or more than the predetermined threshold value may be selected again, and the language analysis metadata which is selected again may be also specified as the test target for determining whether to reanalyze.

The test for determining whether to reanalyze based on the processing step information, the unit input information, the unit result information, and the reliability information of the language analysis metadata which is specified as the test target may be performed (S304).

The test with respect to the unit input information (the input data) may be performed using the processing step information of the language analysis metadata which is specified as the test target for the above description.

For example, the test may be performed, using the processing step information, on the unit input information (the input data) of the language analysis metadata which is specified as the test target using the language knowledge resources in which the language knowledge is accumulated according to the continuous increase.

The test result information and the unit result information of the language analysis metadata which is specified as the test target may be compared (S305).

Based on the comparison result, when the transmitted test result information and the unit result information of the language analysis metadata which is specified as the test target are not identical, whether the reliability value corresponding to the test result information and the reliability information (the reliability value) of the language analysis metadata which is specified as the test target is within the statistically predetermined significant range may be tested using the statistical test method such as a t-test, etc.

Based on the test result, when the reliability value corresponding to the test result information and the reliability information (the reliability value) of the language analysis metadata which is specified as the test target are not within the statistically predetermined significant range, it may be determined that the language analysis metadata which is specified as the test target should be reanalyzed.

The language analysis operation after the processing step of the language analysis metadata in which it is determined to be reanalyzed may be performed again (S306).

The language analysis result corresponding to the reanalyzed language analysis metadata among the stored language analysis results may be updated based on the language analysis result which is performed again (S307).

According to the present invention, since the update to a more exact language analysis result can be performed by detecting a portion which can analyze more exactly based on a portion which is imprecisely analyzed in the previously analyzed language analysis result with respect to the large documents and the newly added language knowledge (according to the expansion of the knowledge base), performance of an improved analyzer may be reflected in the language analysis result which is previously analyzed even when all of the large documents is not analyzed again.

Specifically, since only a portion which can be analyzed more exactly among the language analysis results which are previously analyzed is detected and analyzed, the language analysis can be effectively performed.

Further, since the knowledge of the language knowledge base which is increasing in real time can be used, the language analysis result can be improved in real time.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An apparatus for updating a language analysis result, comprising:
a storage unit configured to store the language analysis result and language analysis metadata to be used for update of the language analysis result; and
an update unit configured to reanalyze the language analysis metadata based on language knowledge which is added to language knowledge resources, and update the language analysis result based on the reanalyzed result.

2. The apparatus for updating the language analysis result of claim 1, wherein the language analysis metadata includes at least one among time stamp information, language analysis version information, document ID information, domain information, sentence ID information, original document information, tag information, processing module information, unit input information, unit result information, reliability information, and reserve information.

3. The apparatus for updating the language analysis result of claim 2, wherein the update unit comprises:
a detection unit configured to detect resource increase statistical information and added word information based on added language knowledge when it is confirmed that the language knowledge is added to the language knowledge resources;
a determination unit configured to select the language analysis metadata to be reanalyzed among the stored language analysis metadata based on the resource increase statistical information and the added word information detected by the detection unit; and
an analysis unit configured to perform a subdivided analysis on the unit input information of the selected language analysis metadata using the processing module information of the language analysis metadata selected by the determination unit.

4. The apparatus for updating the language analysis result of claim 3, wherein the update unit selects the language analysis metadata in which an increase value of the domain information or the tag information is equal to or more than a predetermined reference increase value among the stored language analysis metadata based on the detected resource increase statistical information and the added word information.

5. The apparatus for updating the language analysis result of claim 4, wherein the update unit performs the subdivided analysis on the unit input information of the selected language analysis metadata using the processing module information of the selected language analysis metadata, and outputs subdivided analysis result information and reliability information according to the subdivided analysis.

6. The apparatus for updating the language analysis result of claim 5, wherein the update unit compares the subdivided analysis result information output by the analysis unit and the unit result information of the selected language analysis metadata, and when it is determined that the subdivided analysis result information and the unit result information are not identical based on the comparison result, determines whether the reliability information output by the analysis unit and the reliability information of the selected language analysis metadata are within a predetermined range.

7. The apparatus for updating the language analysis result of claim 6, wherein the update unit performs the subdivided analysis on the selected language analysis metadata again using the language knowledge added from a processing module included in the processing module information of the selected language analysis metadata when the reliability information output based on the determination result and the reliability information of the selected language analysis metadata are not within the predetermined range.

8. The apparatus for updating the language analysis result of claim 7, wherein the update unit updates the language analysis result corresponding to the selected language analysis metadata among the stored language analysis result based on a reanalyzed result obtained by performing the subdivided analysis on the selected language analysis metadata again.

9. The apparatus for updating the language analysis result of claim 1, wherein the update unit stores the language analysis metadata to be used for update of the language analysis result in which the reliability value is equal to or less than a predetermined reliability value in the storage unit when the reliability value corresponding to the language analysis result among the language analysis results obtained by performing the language analysis is equal to or less than the predetermined reliability value.

10. The apparatus for updating the language analysis result of claim 1, the storage unit comprises:
a language analysis result storage region configured to store the language analysis result; and
a language analysis metadata storage region configured to store the language analysis metadata.

11. A method of updating a language analysis result, comprising:
storing the language analysis result and language analysis metadata to be used for update of the language analysis result; and
reanalyzing the language analysis metadata based on language knowledge which is added to language knowledge resources, and updating the language analysis result based on the reanalyzed result.

12. The method of updating the language analysis result of claim 11, wherein the language analysis metadata includes at least one among time stamp information, language analysis version information, document ID information, domain information, sentence ID information, original document information, tag information, processing module information, unit input information, unit result information, reliability information, and reserve information.

13. The method of updating the language analysis result of claim 12, wherein the updating of the language analysis result comprises:
detecting resource increase statistical information and added word information based on added language knowledge when it is confirmed that the language knowledge is added to the language knowledge resources;
selecting the language analysis metadata to be reanalyzed among the stored language analysis metadata based on the detected resource increase statistical information and the added word information; and
performing a subdivided analysis on the unit input information of the selected language analysis metadata using the processing module information of the selected language analysis metadata.

14. The method of updating the language analysis result of claim 13, wherein the selecting of the language analysis metadata includes selecting the language analysis metadata in which an increase value of the domain information or the tag information is equal to or more than a predetermined increase value based on the detected resource increase statistical information and the added word information among the stored language analysis metadata.

15. The method of updating the language analysis result of claim 14, wherein the performing of the subdivided analysis comprises:
performing the subdivided analysis on the unit input information of the selected language analysis metadata using the processing module information of the selected language analysis metadata; and
outputting subdivided analysis result information and reliability information according to the subdivided analysis.

16. The method of updating the language analysis result of claim 15, wherein the performing of the subdivided analysis further comprises:
comparing the output subdivided analysis result information and the unit result information of the selected language analysis metadata; and
when it is determined that the subdivided analysis result information and the unit result information are not identical based on the comparison result, determining whether the reliability information output by an analysis unit and the reliability information of the selected language analysis metadata are within a predetermined range.

17. The method of updating the language analysis result of claim 16, wherein the performing of the subdivided analysis further comprises:
performing the subdivided analysis on the selected language analysis metadata using the language knowledge added from a processing module included in the processing module information of the selected language analysis metadata when the reliability information output based on the determination result and the reliability information of the selected language analysis metadata are not within the predetermined range.

18. The method of updating the language analysis result of claim 17, wherein the updating of the language analysis result includes updating the language analysis result corresponding to the selected language analysis metadata among the stored language analysis results based on the reanalyzed result obtained by performing the subdivided analysis on the selected language analysis metadata again.

19. The method of updating the language analysis result of claim 11, wherein the storing of the language analysis metadata comprises:
determining whether the reliability value corresponding to the language analysis result is equal to or less than a predetermined reliability value among the language analysis results obtained by performing the language analysis; and
storing the language analysis metadata to be used for update of the language analysis result in which the reliability value is equal to or less than the predetermined reliability value when the reliability value corresponding to the language analysis result is equal to or less than the predetermined reliability value based on the determination result.

20. The method of updating the language analysis result of claim 11, the storing of the language analysis metadata comprises:
storing the language analysis result in a language analysis storage region; and
storing the language analysis metadata in a language analysis metadata storage region.
